(19) United States
(12) Patent Application Publication
(10) Pub. No.: US 2020/0191621 A1
(43) Pub. Date: Jun. 18, 2020

(54) FITTING WITH A LIQUID SEAL

(71) Applicant: Ingersoll-Rand Industrial U.S., Inc., Davidson, NC (US)

(72) Inventor: Kenneth Brandon Teague, Statesville, NC (US)

(21) Appl. No.: 16/797,876

(22) Filed: Feb. 21, 2020

Related U.S. Application Data
(63) Continuation of application No. 14/941,895, filed on Nov. 16, 2015.

(51) Int. Cl. G01D 11/30; G01L 19/00

(52) U.S. Cl. CPC G01D 11/30; G01L 19/003

(57) ABSTRACT

The present disclosure is directed to an instrumentation fitting with a liquid seal to prevent fluid leakage therefrom. The instrumentation fitting includes a connector configured to connect to an apparatus having a pressurized region with fluid therein. A sealing grommet is positionable within the connector and an extension tube is engageable with the sealing grommet within the connector. The extension tube is configured to extend to a height H above the pressurized region and fill with liquid to a height level h to provide a hydraulic head sufficient to equalize the pressure within the pressurized region.

### TECHNICAL FIELD

The present application generally relates to a connector fitting configured to permit instrumentation lines or the like to egress from a pressurized internal region of a machine to an external location and more particularly, but not exclusively, to a fitting having a liquid seal to prevent fluid from egressing from the pressurized region and leaking from the fitting.

### BACKGROUND

Measuring parameters such as pressure, temperature, flow rate or the like in an internally pressurized region of a machine such as a compressor system can be difficult in certain aspects. For example, when running the instrumentation wiring from a pressurized region to an external location a fluid leak path may be formed at an interface between the connector and instrumentation line in certain applications. Some existing systems have various shortcomings relative to certain applications. Accordingly, there remains a need for further contributions in this area of technology.

### SUMMARY

One embodiment of the present application is a unique instrumentation fitting with a fluid seal to prevent external fluid leakage at a connector interface. Other embodiments include apparatuses, systems, devices, hardware, methods, and combinations for compressor systems with a unique instrumentation fitting with a fluid seal. Further embodiments, forms, features, aspects, benefits, and advantages of the present application shall become apparent from the description and figures provided herewith.

### BRIEF DESCRIPTION OF THE FIGURES

FIG. 1 is a cross-sectional view of an exemplary apparatus having instrumentation lines egressing from a pressurized region through a fitting according to one embodiment of the present disclosure;

FIG. 2 is an exploded perspective view of a connector fitting with fluid sealing according to one embodiment;

FIG. 3 is a cross sectional view of the connector fitting of FIG. 2;

FIG. 4 is an exploded perspective view of a connector fitting with fluid sealing according to another embodiment;

FIG. 5 is a cross sectional view of the connector fitting of FIG. 4; and

FIG. 6 is view of a portion of a connector fitting with an optional tube outlet seal.

### DETAILED DESCRIPTION OF THE ILLUSTRATIVE EMBODIMENTS

For the purposes of promoting an understanding of the principles of the application, reference will now be made to the embodiments illustrated in the drawings and specific language will be used to describe the same. It will nevertheless be understood that no limitation of the scope of the application is thereby intended. Any alterations and further modifications in the described embodiments, and any further applications of the principles of the application as described herein are contemplated as would normally occur to one skilled in the art to which the application relates.

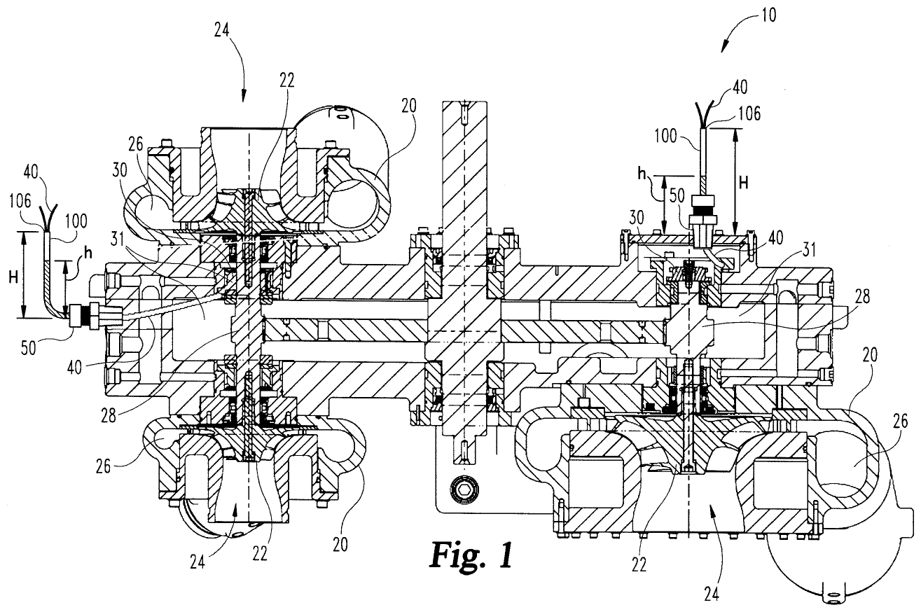

Referring now to FIG. 1, an apparatus 10 such as a compressor system or the like illustrative of an exemplary machine that may implement the teachings of the present application is disclosed therein. It should be understood that the apparatus 10 need not conform to the particular configuration depicted in FIG. 1, but to the contrary can be of any form of machine having instrumentation egressing from internal portions thereof. The exemplary compressor system 10 can include a compressor housing 20 with an impeller 22 rotatably supported therein. A compressor inlet 24 is formed in the housing 20 to provide a pathway for directing compressible fluid such as air or the like to the impeller 22. When the impeller 22 is rotated, the fluid is compressed to a higher pressure and discharged into a volute 26 and then directed to external conduits as desired. The compressor impeller 22 can be rotatingly supported with bearings 30 in various locations along a shaft 28. The compressor system 10 can include an oil feed system (not shown) that delivers pressurized oil to the bearings 30 or other pressurized internal locations 31. Pressurization of the internal locations 31 can occur when pressurized fluid from impeller 22 or volute 26 is directed either by design or by leakage into the internal location and/or from the pressurized injection of a flow of oil from a lubrication pump (not shown).

In certain applications, an instrumentation line or wire 40 can be routed from a pressurized region 31 where defined parameters are measured such as pressure, temperature, mass flow rate and the like. It should be noted that an instrumentation line or wire can include multiple lines or wires and may be covered individually and/or with a single outer sheathing. The pressurized region 31 can include fluid in the form of liquid, vapor or mixtures thereof. The instrumentation line 40 can be directed through various portions of the housing 20 and through a fitting 50 that is connected via threaded engagement or other mechanical means to a wall of the housing 20. The instrumentation line 40 can be routed from the fitting 50 to an external location wherein a sensor, computer or other signal processing device (not shown) can be operably connected thereto.

In some prior art configurations, the pressurized region 31 can force fluid in vapor or liquid form to leak past instrumentation seals in a fitting 50 and cause an external fluid leak. The present disclosure provides for a tube 100 extending from the fitting 50 such that the tube 100 may fill partially with liquid that has leaked past the instrumentation seals in the fitting 50. Liquid condensed from vapor or the like may rise to a height level h to define a hydraulic head that equalizes the internal pressure of the pressurized region 31. When the hydraulic head in the tube equalizes the internal pressure then fluid will be prevented from leaking out of the outlet end 106 of the tube 100. In this manner the instrumentation line 40 can extend from outlet end 106 of the tube 100 while fluid in liquid form is prevented from leaking out of the tube 100. For example, if the internal pressure of the pressurized region is equivalent to two inches of water (H₂O) then the tube height H would necessarily extend to an equivalent of at least two inches above the fitting connection location so as to provide an equilibrium hydraulic force. In practice, the height of the tube 100 may be greater than two inches so as to provide for a margin of safety. Furthermore, the density of the fluid in the pressurized region would need to be determined before the height H of the tube 100 is defined.

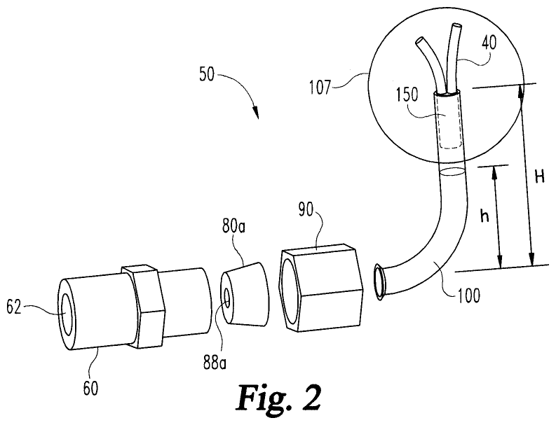

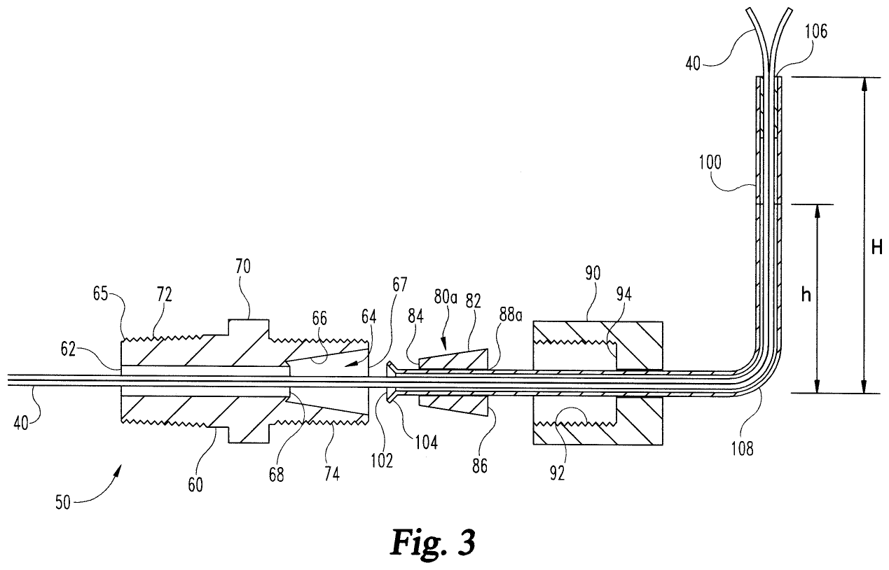

Referring now to FIGS. 2 and 3, a perspective view and a cross-sectional view of a first embodiment of the fitting 50 are illustrated respectively therein. The fitting 50 can include a connector 60 configured to permit an instrumentation line 40 to pass through from a pressurized region of a machine and out through an extension tube 100. The instrumentation line 40 can be constructed with a meshed wire outer cladding or other surface materials that may or may not be porous in nature which can permit liquid and gas to leak past a grommet seal 80a and an optional outlet seal 150 such that a standard traditional fitting 50 may not be capable of preventing all external fluid leakage. In some forms, the instrumentation line 40 can include a plurality of lines or wires thereby permitting a fluid leak path to form between adjacent pairs of wires. The instrumentation line(s) 40 extend from the fitting 50 and can connect to a sensor or electronic controller and the like to transmit a parameter signal from the pressurized region.

The height H of the outlet end 106 of the tube 100 above an installed connector location on the housing 20 defines the amount of pressure that a liquid seal in the tube 100 can withstand before any leakage from the outlet end 106 of the tube 100 occurs. The liquid seal is defined by a height h of a liquid column formed within the tube 100 due to the internal pressure of the pressurized region 31. When a liquid such as oil or the like passes from the pressurized region into an inlet 102 of the tube 100, the liquid will rise to a height h in the tube 100 whereby the hydraulic head of the liquid will equalize the pressure in the internal region 31 so as to prevent fluid including gas and liquid forms from leaking out of the outlet end 106 while still permitting the instrumentation line(s) 40 to egress from the tube 100.

A through bore 62 can be formed through the fitting 60 for the instrumentation line 40 to extend therethrough between first and second ends 65, 67 thereof. A seal receiving region 64 can be formed adjacent the second end 67 of the connector 60. The seal receiving region 64 can include a tapered wall 66 that diverges outward from the first end 65 towards the second end 67 of the connector 60. The seal receiving region 64 may have a tube abutment portion 68 configured to engagingly receive the inlet end 102 of the tube 100 in a sealing arrangement. The inlet end 102 of the tube 100 may include a flare coupling 104 for engagement with the abutment portion 68 to provide a sealing interface therebetween. In some forms, the tube may not directly engage with the connector 60 and fluid sealing is controlled substantially by the grommet seal 80a. In some forms an outlet seal 150 can be positioned adjacent the outlet end 106 of the tube 100 to provide stability for the instrumentation line 40 and provide additional sealing means for the fitting 50.

The fitting 50 can include an integral hex nut 70 or the like formed between the first and second ends 65, 67 so as to provide a reacting portion for a tool such as a wrench or the like to engage and tighten a first threaded portion 72 of the fitting 50 into a threaded aperture (not shown) of the compressor housing 20. The first threaded portion 72 adjacent the first end 65 of the fitting 50 can be threadingly engaged with the compressor 20 in one form of the present application. Other forms can include one or more mechanical connecting features such as “quick disconnects” or features that are permanently fixed to the housing 20 such as a welded portion or the like. A second threaded portion 74 can be formed adjacent the second end 67 of the connector 60. The second threaded portion 74 is configured to threadingly receive a fitting lock nut 90 and will be described further below.

The grommet seal 80a can include a through bore 88a extending between a first end 84 and a second end 86 thereof. The through bore 88a can be sized to form a press fit seal with an outer wall of the tube 100 upon installation in the connector 60. The grommet seal 80a can further include a tapered outer wall 82 that diverges outward from the first end 84 toward the second end 86. The tapered wall 82 is configured to sealingly engage with the tapered wall 66 of the fitting connector 60 in an installed position. When the grommet 80a is inserted into the seal receiving region 64 of the connector 60 with the tube 100 extending into the through bore 88a, a fluid seal is formed between the tube 100 and the connector 60. After seating the grommet seal 80a in the seal receiving region 64, a lock nut 90 can be threadingly engaged with the second threaded portion 74 of the connector 60 to hold the grommet seal 80a in a desired location. The lock nut 90 can include an internal threaded portion 92 that terminates at a back wall 94 thereof. The lock nut 90 can be threaded onto the second threaded portion 74, such that the back wall 94 of the nut 90 can engage with the grommet seal 80a and position the grommet seal 80a in a desired location relative to the seal receiving region 64 of the connector 60. In other forms the grommet 80a can be held in fixed position relative to the tube 100 and need not be directly contacted by the back wall 94 of the lock nut 90. By way of example and not limitation the seal grommet 80a may be press fit, glued or otherwise affixed to the tube 100 such that when the tube 100 is positioned in a final assembled position, then the grommet 80a will also be located in a final assembled position. In some embodiments the lock nut 90 may not include threads for mechanical attachment to the connector 60, but may be attached by press fit or a “quick disconnect” type in lieu of a threaded nut as shown in the illustrative embodiment.

The tube 100 can include one or more curved sections 108 as desired. In some forms the tube may not include any curved sections, but may be substantially straight as illustrated by the fitting on the right side of the system shown in FIG. 1. The curvature of the tube 100 will depend on where and how the fitting 50 is connected relative to the compressor housing 20. Although not shown, one skilled in the art will understand that the locknut 90 will necessarily engage with an abutment portion connected to the tube 100 in order to hold the tube in fixed position relative to the connector 60 when in an installed position.

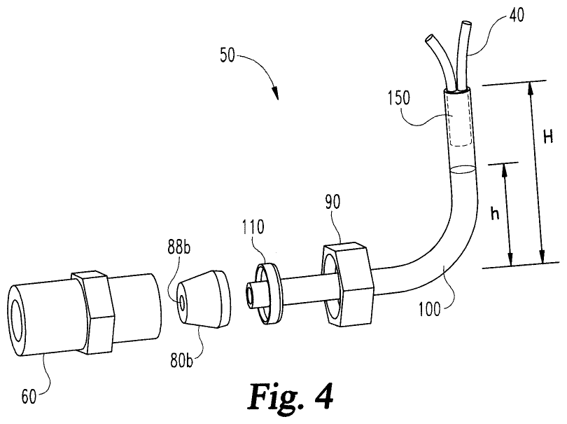

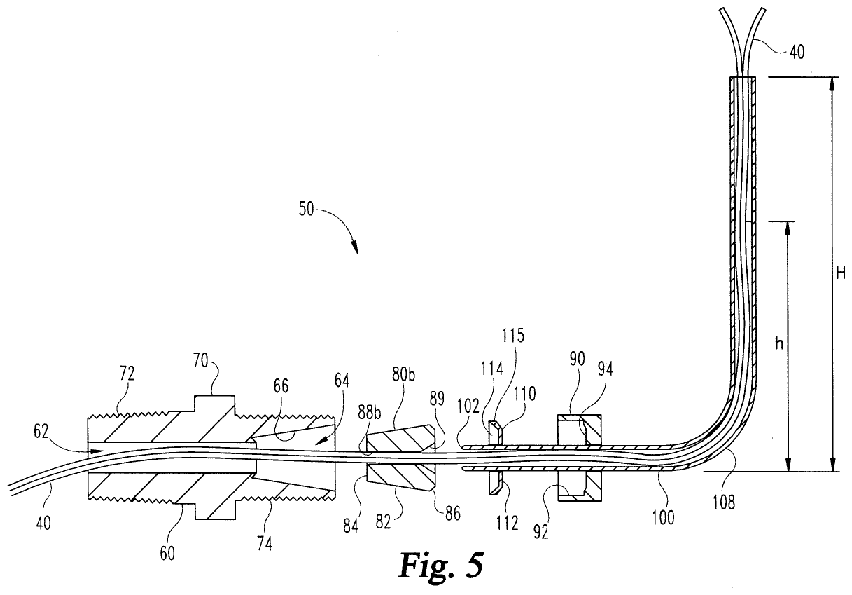

Referring now to FIGS. 4 and 5, a second embodiment of the present application is depicted therein. The fitting 50 includes many of the same features as those described in the embodiment of FIGS. 2 and 3. In this embodiment, a washer 110 can be utilized in combination with an alternate grommet seal 80b to form a sealing arrangement therebetween. The alternate grommet seal 80b can include a chamfer portion 89 to provide a lead in for an inlet end 102 of the tube 100 to pass into the inner bore 88b thereof. In one form the inlet end 102 of the tube 100 can be positioned at an intermediate position between the first end 84 and the second end 86 of the grommet seal 80b in an installed configuration. Alternatively the inlet end 102 of the tube 100 can pass completely through the seal grommet 80b in an installed configuration. In one form, the inner bore 88b can be sized to closely fit with instrumentation wires 40 passing therethrough. The inner bore 88b may form a fluid seal at the interface between the wires 40 and the grommet seal 80b. In some forms the interface seal at the inner bore 88b may not prevent all vapor from passing through the interface of wire 40 due to the configuration of the sheath or outer cover of the instrumentation wires 40.

The washer 110 can be fixed to the tube 100 such that the washer will engage directly with the grommet seal 80b at the second end 86 thereof to form a sealing interface therebetween. The washer 110 can be welded, press fit or otherwise mechanically attached to the tube 100 such that a fluid tight seal is formed between the washer 110 and the tube 100. The washer 110 can include a receiving cavity 114 formed so that a portion of the grommet seal 80b can reside therein in an installed configuration. In some forms the washer can be substantially rigid and other forms the washer can be somewhat compliant and deformable so as to provide flexibility when engaging with the grommet seal 80b. An outer edge 115 of the washer 110 may engage around an outer perimeter of the grommet seal 80b proximate the second end 86 thereof.

The lock nut 90 can then be engaged with the second threaded portion 74 of the connector 60 to hold the tube 100 and the washer 110 in fixed position relative to the grommet seal 80b. Similar to grommet seal 80a, the grommet seal 80b includes a tapered wall 82 operable for sealingly engaging with the inner tapered wall 66 of the connector 60. In this manner the tube 100 and washer 110 can engage in a sealing arrangement such that any liquid passing through the bore 62 of the connector 60 will remain internal to the tube 100. As described above, the liquid will rise to a height h below the height H of the tube 100, that corresponds with a hydraulic head equal to the pressure in the pressurized region 31, and will thus prevent fluid leakage from the fitting 50.

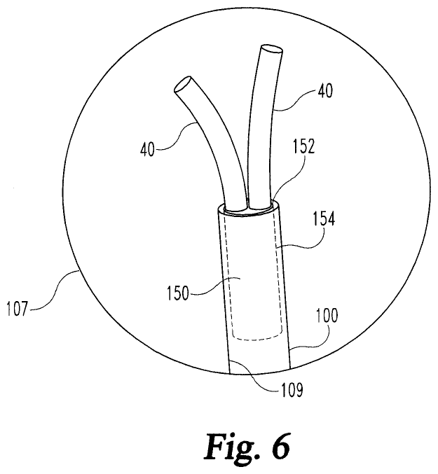

Referring now to FIG. 6 an enlarged view of an outlet end 107 of the tube 100 is shown wherein an outer seal 150 is positioned in an alternate or optional configuration. The outer seal 150 can include one or more through holes 152 for one or more instrumentation lines 40 to be inserted therethrough. The outer seal 150 can include an outer seal wall 154 that can be sealingly engaged with an inner wall 109 of the tube 100 so as to provide an additional seal for impeding gaseous fluid that may rise through a liquid column in the tube 100.

Materials for forming each of the components of the fitting connector 50 may include metals, metal alloys, composites, plastics, elastomers, rubber compounds and other manmade or natural compounds.

In operation, an instrumentation fitting according the present disclosure will prevent fluid from leaking from a fitting interface outlet through which instrumentation lines are routed from a pressurized region of a machine. A liquid seal is formed in an extension tube when pressure from the pressurized region forces liquid from the pressurized region into the fitting and through pathways formed for instrumentation line routing. The liquid will rise to a height whereby the hydraulic head is equivalent to the pressure in the pressurized region. Any liquid that enters the fitting from the pressurized region will be transported up into the extension tube but will be prevented from leaking from the outlet of the extension tube due to the liquid seal defined by the fitting. In this manner instrumentation can be routed externally through a fitting from an internal pressurized region without causing external leakage of fluid from the machine.

In one aspect, the present disclosure includes a compressor system comprising: A fitting comprising: a connector configured to connect to an apparatus having a pressurized region with fluid therein; a sealing grommet positionable within the connector; a tube engageable with the sealing grommet within the connector; a nut configured to releasably hold the tube in a sealing arrangement with the connector; and wherein the tube is configured to extend to a height H above the pressurized region and fill with fluid to a height level h to provide a hydraulic head sufficient to equalize the pressure within the pressurized region.

In refining aspects the present disclosure further comprises an instrumentation line extending from the pressurized region and egressing out from the tube; wherein the instrumentation line transmits a signal indicative of a parameter measurement in the pressurized region; wherein the parameter measurement includes one of a pressure, a temperature or a flow measurement; wherein the instrumentation line includes a braided external sheath; wherein the instrumentation line includes multiple lines; wherein the sealing grommet includes a tapered outer wall engageable with a tapered inner wall of the connector and a through hole configured to receive a portion of the tube; wherein a forward end of the tube extends completely through the sealing grommet and engages with the connector in an installed position; wherein the tube includes a curved portion; further comprising an outlet seal positioned proximate an outlet end of the tube; wherein the outlet seal includes a through aperture for an instrumentation line to extend therethrough; further comprising a seal washer fixed to the tube and engageable with the sealing grommet; and wherein the grommet sealingly engages with the tube, the connector and instrumentation line in an installed position.

In another aspect, the present disclosure includes a fitting comprising: a connector configured to connect to an apparatus having a pressurized region with fluid therein; a sealing grommet with an internal channel positionable within the connector; a tube engageable within the internal channel of the sealing grommet; a seal washer fixed to the tube and engageable with an end of the sealing grommet; and a nut configured to releasably hold the tube in a sealing arrangement with the connector.

In refining aspects, the fitting further comprises an instrumentation line extending from the pressurized region and egressing out from the tube; wherein the seal washer is of a rigid construction; wherein the seal washer is fixed with a fluid tight seal at an interface with the tube; wherein the sealing grommet includes a tapered outer wall engageable with an inner wall of the connector and a through hole configured to receive a portion of the tube; wherein a forward end of the tube is positioned within the sealing grommet in an installed position; wherein the seal washer is sealingly engaged with an end of the sealing grommet; wherein the seal washer includes a recessed cavity for receiving a portion of the sealing grommet therein; further comprising an outlet seal positioned within an outlet end of the tube grommet and the grommet sealingly engages with the tube, the connector and instrumentation lines in an installed position.

Another aspect includes a method comprising: measuring a parameter within a pressurized fluid region of a machine; connecting a fitting with a tube extending therefrom to the machine; routing an instrumentation line from the pressurized region through the fitting and out of an outlet of the tube; wherein the tube extends to a predefined height H above a fitting connection location; and filling the tube with liquid from the pressurized region to a height h sufficient to prevent fluid from the pressurized region from egressing out of the tube outlet.

Refining aspects include sealingly engaging the fitting, the tube and an instrumentation line proximate a forward end of the tube with a sealing grommet and sealing the instrumentation line proximate an aft end of the tube with an outlet seal.

While the application has been illustrated and described in detail in the drawings and foregoing description, the same is to be considered as illustrative and not restrictive in character, it being understood that only the preferred embodiments have been shown and described and that all changes and modifications that come within the spirit of the applications are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A fitting comprising:
a connector configured to connect to an apparatus having a pressurized region with fluid therein;
a sealing grommet positionable within the connector;
a tube engageable with the sealing grommet within the connector;
a nut configured to releasably hold the tube in a sealing arrangement with the connector; and
wherein the tube is configured to extend to a height H above the pressurized region and fill with fluid to a height level h to provide a hydraulic head sufficient to equalize the pressure within the pressurized region.

2. The fitting of claim 1 further comprising an instrumentation line extending from the pressurized region and egressing out from the tube.

3. The fitting of claim 2, wherein the instrumentation line transmits a signal indicative of a parameter measurement in the pressurized region.

4. The fitting of claim 3, wherein the parameter measurement includes one of a pressure, a temperature or a flow measurement.

5. The fitting of claim 2, wherein the instrumentation line includes a braided external sheath.

6. The fitting of claim 2, wherein the instrumentation line includes multiple lines.

7. The fitting of claim 1, wherein the sealing grommet includes a tapered outer wall engageable with a tapered inner wall of the connector and a through hole configured to receive a portion of the tube.

8. The fitting of claim 7, wherein a forward end of the tube extends completely through the sealing grommet and engages with the connector in an installed position.

9. The compressor system of claim 1, wherein the tube includes a curved portion.

10. The fitting of claim 1 further comprising an outlet seal positioned proximate an outlet end of the tube.

11. The fitting of claim 10, wherein the outlet seal includes a through aperture for an instrumentation line to extend therethrough.

12. The fitting of claim 1, further comprising a seal washer fixed to the tube and engageable with the sealing grommet.

13. The fitting of claim 1, wherein grommet sealingly engages with the tube, the connector and an instrumentation line in an installed position.

14. A fitting comprising:
a connector configured to connect to an apparatus having a pressurized region with fluid therein;
a sealing grommet with an internal channel positionable within the connector;
a tube engageable within the internal channel of the sealing grommet;
a seal washer fixed to the tube and engageable with an end of the sealing grommet; and
a nut configured to releasably hold the tube in a sealing arrangement with the connector.

15. The fitting of claim 14 further comprising an instrumentation line extending from the pressurized region and egressing out from the tube.

16. The fitting of claim 14, wherein the seal washer is of a rigid construction.

17. The fitting of claim 14, wherein the seal washer is fixed with a fluid tight seal at an interface with the tube.

18. The fitting of claim 14, wherein the sealing grommet includes a tapered outer wall engageable with an inner wall of the connector and a through hole configured to receive a portion of the tube.

19. The fitting of claim 18, wherein a forward end of the tube is positioned within the sealing grommet in an installed position.

20. The compressor system of claim 14, wherein the seal washer is sealingly engaged with an end of the sealing grommet.
